(19) United States
(12) Patent Application Publication
(10) Pub. No.: US 2007/0169465 A1
(43) Pub. Date: Jul. 26, 2007

(54) Air-fuel ratio control apparatus for internal combustion engine

(75) Inventors: Norihisa Nakagawa, Numazu-shi (JP); Takahiko Fujiwara, Susono-shi (JP); Taiga Hagimoto, Susono-shi (JP); Junichi Kako, Susono-shi (JP); Naoto Kato, Susono-shi (JP); Shuntaro Okazaki, Susono-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, TOYOTA-SHI (JP)

(21) Appl. No.: 11/647,243

(22) Filed: Dec. 29, 2006

(30) Foreign Application Priority Data
Jan. 26, 2006 (JP) 2006-017467

(51) Int. Cl. F01N 3/00; F02D 41/14

(52) U.S. Cl. 60/276; 123/674; 123/696

(57) ABSTRACT

The output from an air-fuel ratio sensor is corrected using an integral term that is calculated by integrating values of deviation of the output from an oxygen sensor with respect to a reference output that would be obtained when the combustion air-fuel ratio is stoichiometric, when an engine operates with a target combustion air-fuel ratio set to the stoichiometric air-fuel ratio. A fuel-cutoff prohibition period in which fuel supply cutoff is prohibited is set so that the engine continues to operate with the target combustion air-fuel ratio set to the stoichiometric air-fuel ratio, until the integral term is updated at least once. The integral term may be updated when a predetermined updating condition is satisfied.

### INCORPORATION BY REFERENCE

The disclosure of Japanese Patent Application No. 2006-017467 filed on Jan. 26, 2006, including the specification, drawings and abstract is incorporated herein by reference in its entirety.

### BACKGROUND OF THE INVENTION

1. Field of the Invention

The invention relates to an air-fuel ratio control apparatus for an internal combustion engine.

2. Description of the Related Art

It is proposed to provide an air-fuel ratio sensor in the exhaust system for an engine, and to control the air-fuel ratio of air-fuel mixture during combustion (hereinafter, referred to as “combustion air-fuel ratio”) to a desired air-fuel ratio based on the output from the air-fuel ratio sensor. The output from the air-fuel ratio sensor linearly changes. In the exhaust system for the engine, a three-way catalyst device is generally provided to purify exhaust gas. The three-way catalyst device appropriately purifies the exhaust gas when the air-fuel ratio of the exhaust gas is near the stoichiometric air-fuel ratio. The three-way catalyst device generally has the ability to store oxygen (hereinafter, referred to as “oxygen-storage ability”). Thus, when the air-fuel ratio of the exhaust gas flowing into the three-way catalyst device is leaner than the stoichiometric air-fuel ratio, the three-way catalyst device stores the excess oxygen. When the air-fuel ratio of the exhaust gas flowing into the three-way catalyst device is richer than the stoichiometric air-fuel ratio, the three-way catalyst device releases oxygen to make up the shortage of oxygen. Thus, the air-fuel ratio of the exhaust gas in the three-way catalyst is near the stoichiometric air-fuel ratio.

Therefore, the air-fuel ratio sensor, which is used to detect the combustion air-fuel ratio, is disposed upstream of the three-way catalyst device so that the detected air-fuel ratio of exhaust gas is not adversely influenced by the oxygen-storage ability of the three-way catalyst device. An oxygen sensor is disposed downstream of the three-way catalyst device. The output from the oxygen sensor sharply changes when the air-fuel ratio of exhaust gas approaches the stoichiometric air-fuel ratio. The output from the oxygen sensor gradually changes due to the oxygen storage ability. The output from the air-fuel ratio sensor may indicate a value richer or leaner than the actual value. Therefore, the output from the air-fuel ratio sensor is corrected based on the output from the oxygen sensor, to accurately execute the air-fuel ratio using the air-fuel ratio sensor.

The output from the air-fuel ratio sensor is generally corrected based on the output from the oxygen sensor, using a proportional term and an integral term when the engine operates with a target combustion air-fuel ratio set to the stoichiometric air-fuel ratio. The proportional term is calculated based on the deviation of the actual output from the oxygen sensor with respect to a reference output from the oxygen sensor that would be obtained when the combustion air-fuel ratio is stoichiometric. The integral term is calculated by integrating the values of the deviation of the actual output from the oxygen sensor. The integral term corrects the deviation of the output from the air-fuel ratio sensor in a recent specific period. The proportional term corrects the current deviation of the output from the air-fuel ratio sensor that is corrected by the integral term. The integral term is updated to a value appropriate for correcting the deviation of the output from the air-fuel ratio sensor at an updating timing, for example, when the value of deviation of the actual output from the oxygen sensor has been calculated a predetermined number of times.

In an internal combustion engine, the fuel supply is frequently cut off to reduce the amount of fuel consumed. For example, the fuel supply is cut off each time the engine decelerates. When the fuel supply is cut off, air flows into the three-way catalyst device as exhaust gas. Because the three-way catalyst device is capable of storing oxygen, the three-way catalyst device stores a large amount of the oxygen in the air flowing through the three-way catalyst. It is preferable to store a desired amount of oxygen in the three-way catalyst device to appropriately purify exhaust gas even if the air-fuel ratio of exhaust gas is leaner or richer than the stoichiometric air-fuel ratio. The desired amount of oxygen is the approximately half of the maximum amount of oxygen that can be stored in the three-way catalyst. Immediately after the fuel supply resumes, the combustion air-fuel ratio is generally controlled to a rich air-fuel ratio to release the excess oxygen that has been stored in the three-way catalyst device when the fuel supply was cut off, so that only the desired amount of oxygen remains in the three-way catalyst device (hereinafter, this control will be referred to as “enriching control”).

During the fuel supply cutoff and the enriching control, the absolute value of the deviation of the actual output from the oxygen sensor with respect to the reference output that would be obtained when the combustion air-fuel ratio is stoichiometric is a large value. That is, the absolute value of the deviation is useless during the fuel supply cutoff. The air-fuel ratio does not need to be controlled during the fuel supply cutoff. Therefore, the updating of the integral term is prohibited during the fuel supply cutoff, because the integral term is calculated by integrating the values of the deviation of the output from the oxygen sensor. During the enriching control, the combustion air-fuel ratio needs to be controlled to the desired rich air-fuel ratio. For example, Japanese Patent Application Publication No. JP-A-2005-61356 describes prohibiting the correction of the output from the air-fuel ratio sensor using the proportional term, and prohibiting the updating of the integral term during the enriching control.

In the above-described related art, the integral term is not updated during the fuel supply cutoff and immediately after fuel supply resumes. Therefore, because the fuel supply is frequently cut off after the engine starts, the integral term is not updated at all while the engine operates. As a result, the output from the air-fuel ratio sensor cannot be corrected using the integral term appropriate for correcting the deviation of the output from the air-fuel ratio sensor, when the enriching control is executed, and when the engine operates with the target combustion air-fuel ratio set to the stoichiometric air-fuel ratio after the enriching control is completed. This makes it difficult to accurately control the air-fuel ratio.

### SUMMARY OF THE INVENTION

A first aspect of the invention relates to an air-fuel ratio control apparatus for an internal combustion engine, which includes an air-fuel ratio sensor, and an oxygen sensor. The air-fuel ratio sensor is disposed upstream of a three-way catalyst device provided in the engine exhaust system. The output from the air-fuel ratio sensor changes according to the air-fuel ratio of exhaust gas. The oxygen sensor is disposed downstream of the three-way catalyst device. The output from the oxygen sensor sharply changes when the air-fuel ratio of the exhaust gas approaches the stoichiometric air-fuel ratio. The air-fuel ratio control apparatus controls a combustion air-fuel ratio to a desired air-fuel ratio, based on the output from the air-fuel ratio sensor. The output from the air-fuel ratio sensor is corrected using an integral term, which is calculated by integrating values of deviation of the output from the oxygen sensor with respect to a reference output that would be obtained when the combustion air-fuel ratio is stoichiometric, when the engine operates with a target combustion air-fuel ratio set to the stoichiometric air-fuel ratio. The integral term is updated when a predetermined updating condition is satisfied. A fuel-cutoff prohibition period in which fuel supply cutoff is prohibited is set so that the engine continues to operate with the target combustion air-fuel ratio set to the stoichiometric air-fuel ratio, until the integral term is updated at least once.

The air-fuel ratio control apparatus for an internal combustion engine according to the first aspect sets the fuel-cutoff prohibition period. During this period, the engine continues to operate with the target combustion air-fuel ratio set to the stoichiometric air-fuel ratio, and the integral term is calculated and updated at least once. The integral term is calculated by integrating the values of deviation from the oxygen sensor with respect to the reference output that would be obtained when the combustion air-fuel ratio is stoichiometric. The integral term corrects the deviation of the output from the air-fuel ratio sensor in a specific period. This avoids the situation where the integral term is not updated due to the frequent fuel supply cutoff. The output from the air-fuel ratio sensor is corrected using the integral term appropriate for correcting the deviation of the signal from the air-fuel ratio sensor. Thus, the combustion air-fuel ratio is appropriately controlled to the stoichiometric air-fuel ratio. Also, the combustion air-fuel ratio is appropriately controlled to a desired rich air-fuel ratio during the enriching control executed after fuel supply resumes.

A second aspect of the invention relates to an air-fuel ratio control method for an internal combustion engine. In the air-fuel ratio control method, an integral term is calculated by integrating values of deviation of an output from an oxygen sensor, disposed downstream of a three-way catalyst device provided in an engine exhaust system, with respect to a reference output that would be obtained when a combustion air-fuel ratio is stoichiometric. An output from an air-fuel ratio sensor, disposed upstream of the three-way catalyst device, is corrected using the integral term when an engine operates with a target combustion air-fuel ratio set to the stoichiometric air-fuel ratio. The combustion air-fuel ratio is controlled to a desired air-fuel ratio based on the corrected output from the air-fuel ratio sensor. The integral term is updated when a predetermined updating condition is satisfied. A fuel-cutoff prohibition period in which fuel supply cutoff is prohibited is set so that the engine continues to operate with the target combustion air-fuel ratio set to the stoichiometric air-fuel ratio until the integral term is updated at least once. The output from the air-fuel ratio sensor changes according to an air-fuel ratio of exhaust gas, and the output from the oxygen sensor sharply changes when the air-fuel ratio of the exhaust gas approaches a stoichiometric air-fuel ratio.

### BRIEF DESCRIPTION OF THE DRAWINGS

The foregoing and/or further objects, features and advantages of the invention will become more apparent from the following description of example embodiments with reference to the accompanying drawings, in which the same or corresponding portions are denoted by the same reference numerals and wherein:

FIG. 1 is a schematic diagram showing the exhaust system for an internal combustion engine controlled by an air-fuel ratio control apparatus according to the invention;

FIG. 2 is a time-chart showing a target combustion air-fuel ratio for the air-fuel ratio control apparatus according to the invention;

FIG. 3 is a first flowchart showing a routine executed by the air-fuel ratio control apparatus according to the invention; and

FIG. 4 is a second flowchart showing another routine executed by the air-fuel ratio control apparatus according to the invention.

### DETAILED DESCRIPTION OF THE EXAMPLE EMBODIMENTS

In the following description, the present invention will be describe in more detail in terms of example embodiments.

FIG. 1 is a schematic diagram showing the exhaust system for an engine. An air-fuel ratio sensor 2 is disposed upstream of a three-way catalyst device 1. An oxygen sensor 3 is disposed downstream of the three-way catalyst device 1. The voltage output from each of the air-fuel ratio sensor 2 and the oxygen sensor 3 changes according to the concentration of oxygen in exhaust gas. The air-fuel ratio sensor 2 is a linear-output type sensor. That is, the output from the air-fuel ratio sensor 2 linearly changes according to the air-fuel ratio of exhaust gas. The output from the oxygen sensor 3 sharply changes when the air-fuel ratio of exhaust gas approaches the stoichiometric air-fuel ratio.

An air-fuel ratio control apparatus according to the invention controls the combustion air-fuel ratio to a desired air-fuel ratio based on the output from the air-fuel ratio sensor 2 through feedback. Because the air-fuel ratio sensor 2 is disposed upstream of the three-way catalyst device 1, the air-fuel ratio sensor 2 is always exposed to exhaust gas that is not purified. Therefore, the output from the air-fuel ratio sensor 2 is not so reliable. The output from the air-fuel ratio sensor 2 may indicate a value richer or leaner than the actual value. In contrast, because the oxygen sensor 3 is disposed downstream of the three-way catalyst device 1, the oxygen sensor 3 is not exposed to the unpurified exhaust gas. Also, the oxygen sensor 3 is generally used to detect whether the air-fuel ratio of exhaust gas is rich or lean. Thus, the output from the oxygen sensor 3 is more reliable. Therefore, the output from the air-fuel ratio sensor 2 is corrected based on the output from the oxygen sensor 3.

When the target combustion air-fuel ratio of the engine is stoichiometric, the output V from the air-fuel ratio sensor 2, which is used in the feedback control of the combustion air-fuel ratio, is corrected to an output V′ according to the following equation.

V′=V+P+I

In this equation, “P” represents the proportional term calculated by multiplying a deviation “d” by a predetermined gain Pg. The deviation “d” is the deviation of the actual output from the oxygen sensor 3 with respect to a reference output (e.g., 0.5 volt) that would be obtained when the combustion air-fuel ratio is stoichiometric. “I” represents the integral term calculated by multiplying the integrated value of the values of deviation “d” by a predetermined gain Ig. The value of deviation “d” is calculated a predetermined number of times, and the integrated value is calculated by integrating the values of deviation “d”. Thus, the integral term I corrects the deviation of the output from the air-fuel ratio sensor 2 in a recent specific period. The proportional term P corrects the current deviation of the output from the air-fuel ratio sensor 2 that has been corrected by the integral term I. The air-fuel ratio of the exhaust gas is accurately estimated based on the output V′ from the air-fuel ratio sensor 2 that is obtained by correcting the output V in the above-described manner. Then, the amount of fuel to be injected with respect to the amount of intake air detected by an airflow meter is corrected through feedback so that the combustion air-fuel ratio becomes stoichiometric.

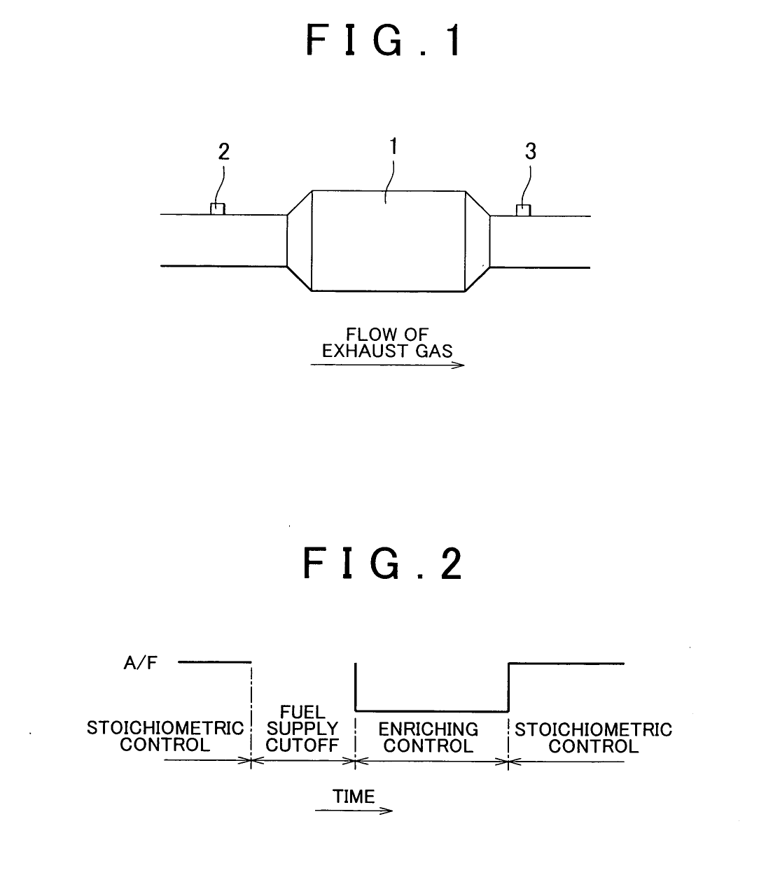

The air-fuel ratio control apparatus controls the combustion air-fuel ratio in an internal combustion engine to the stoichiometric air-fuel ratio. However, as shown in the time-chart in FIG. 2, the air-fuel ratio control is not executed when fuel supply is cut off, that is, when fuel injection is stopped to reduce the amount of fuel consumed, for example, when the engine decelerates. When the fuel supply is cut off, air that contains a large amount of oxygen flows into the three-way catalyst device 1 as exhaust gas. Thus, the amount of oxygen stored in the three-way catalyst device 1 becomes greater than half of the maximum oxygen storage capacity of the three-way catalyst device 1. If the fuel supply is cut off for a long period, the amount of oxygen stored in the three-way catalyst device 1 reaches the maximum oxygen storage capacity. Thus, after the fuel supply resumes, if the combustion air-fuel ratio is leaner than the stoichiometric air-fuel ratio, the ability of the three-way catalyst device 1 to store the excess oxygen is diminished. As a result, the performance of removing NOx is decreased.

Accordingly, after the fuel supply resumes, the combustion air-fuel ratio may be controlled to a desired rich air-fuel ratio to release the oxygen stored in the three-way catalyst device 1 during the fuel supply cutoff, until the amount of oxygen stored in the three-way catalyst device 1 is equal to the approximately half of the maximum oxygen storage capacity (hereinafter, this control will be referred to as “enriching control”). As a result, the air-fuel ratio of exhaust gas in the three-way catalyst device 1 may be maintained at a value near the stoichiometric ratio, regardless of whether the combustion air-fuel ratio is lean or rich. Thus, high performance of removing NOx and high performance of removing CO and HC are maintained. After the enriching control is executed, a stoichiometric target combustion air-fuel ratio is set, and the combustion air-fuel ratio is controlled to the target combustion air-fuel ratio (hereinafter, this control will be referred to as “stoichiometric control”). The enriching control may release almost all the amount of oxygen stored in the three-way catalyst device 1.

When the fuel supply is cut off, and when the enriching control is executed, it is not possible to calculate the value of the deviation “d” of the actual output from the oxygen sensor 3 with respect to the reference output that would be obtained when the combustion air-fuel ratio is stoichiometric. Accordingly, the output from the air-fuel ratio sensor 2 cannot be corrected using the proportional term P during the enriching control. During the enriching control, it is desirable to correct the output from the air-fuel ratio sensor 2 using the integral term I, and to maintain a rich combustion air-fuel ratio based on the corrected output from the air-fuel ratio sensor 2. However, because the value of the deviation “d” cannot be calculated during the enriching control as described above, the integral term I cannot be updated during the enriching control.

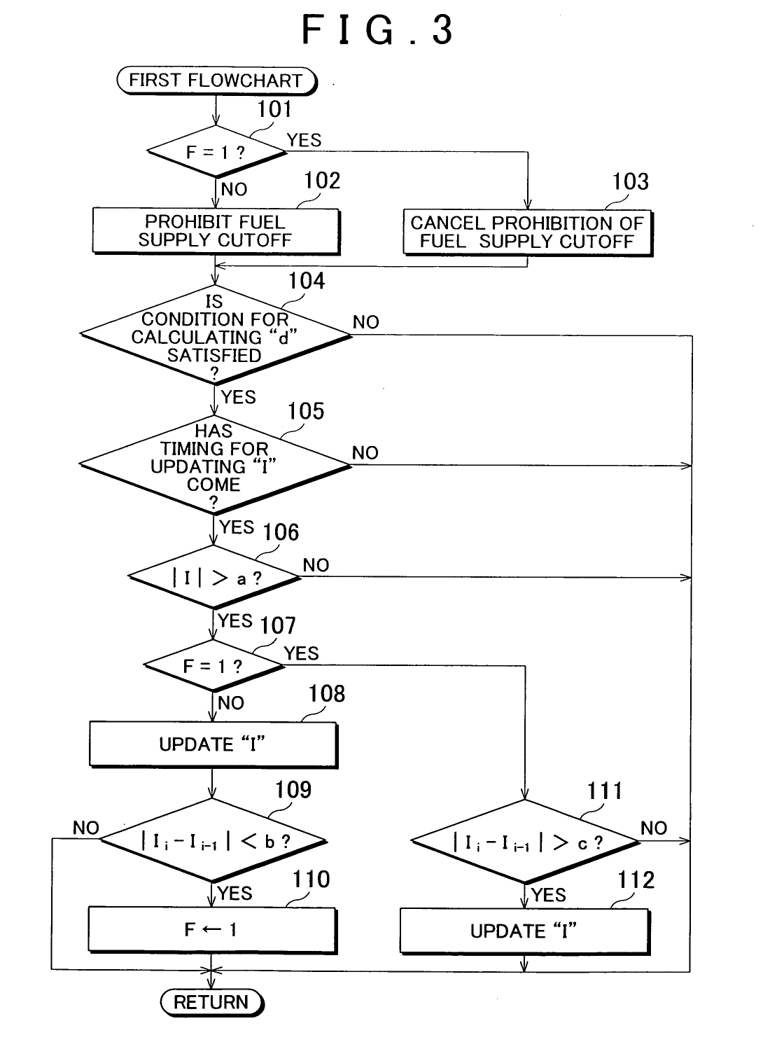

If fuel supply is frequently cut off after the engine starts, the integral I cannot be updated. As a result, the output from the air-fuel ratio sensor 2 cannot be corrected using the integral term I appropriate for correcting the deviation of the output from the air-fuel ratio sensor 2, during the enriching control and the stoichiometric control. Accordingly, the air-fuel ratio control apparatus according to the invention calculates the integral term I appropriate for correcting the deviation of the output from the air-fuel ratio sensor 2, using a first flowchart shown in FIG. 3. Then, the air-fuel ratio control apparatus appropriately corrects the output from the air-fuel ratio sensor 2 so that the combustion air-fuel ratio can be controlled to a desired air-fuel ratio, during the enriching control and the stoichiometric control.

First, in step 101, it is determined whether the value of a flag F is 1. The value of the flag F may be reset to 0 when the engine stops. The value of the flag F may be set to 1, and the value 1 may be stored in a backup RAM when the process of updating/learning the integral term I is completed. When the engine starts, a negative determination is made in step 101, and the routine proceeds to step 102. In step 102, the fuel supply cutoff is prohibited. In step 104, it is determined whether the condition for calculating the value of deviation “d” is satisfied. The deviation “d” is the deviation of the actual output from oxygen sensor 3 with respect to the reference output that would be obtained when the combustion air-fuel ratio is stoichiometric. When the fuel supply cutoff is prohibited, an affirmative determination is made in step 104, unless the engine including the oxygen sensor 3 is warmed up immediately after the engine starts. Then, after the current value of deviation “d” is calculated, the routine proceeds to step 105. If the current value of deviation “d” is calculated in step 104, the output from the air-fuel ratio sensor 2 is corrected using the proportional term P calculated based on the value of deviation “d”, and the integral term I used when the engine was previously stopped. Thus, the stoichiometric control is executed when the fuel supply cutoff is prohibited.

In step 105, the value of the deviation “d” is calculated a predetermined number of times, and it is determined whether the timing for updating the integral term I has come. The integral term I is calculated by integrating the values of deviation “d”. If a negative determination is made in step 105, the routine is terminated. However, if it is determined that the timing for updating the integral term I has come, the routine proceeds to step 106. In step 106, it is determined whether the absolute value of the newly calculated integral term I exceeds a predetermined value “a”. If a negative determination is made, it is determined that the newly calculated integral term I is very small, and therefore the integral term I does not need to be updated, and the routine is terminated. If an affirmative determination is made in step 106, the routine proceeds to step 107. When a negative determination was made in step 101, it is determined that the value of the flag F is 0 in step 107. Therefore, the integral term I is updated to the newly calculated integral term I in step 108. After the integral term I is updated in step 108, the output from the air-fuel ratio sensor 2 is corrected using the newly calculated proportional term P and the updated integral term I, and the stoichiometric control is executed while the fuel supply cutoff is prohibited.

Next, in step 109, it is determined whether the absolute value of the difference between the updated integral term Iᵢ and the integral term Iᵢ₋₁ before updated is smaller than a predetermined value “b”. If an affirmative determination is made, it is determined that the integral term I has sufficiently converged to the value appropriate for correcting the deviation of the output from the air-fuel ratio sensor, and that the process of learning the integral term I is completed. Accordingly, the value of the flag F is set to 1 in step 110. However, if a negative determination is made in step 109, the routine is terminated.

After the value of the flag F is set to 1, an affirmative determination is made in step 101. Therefore, in step 103, the prohibition of the fuel supply cutoff is cancelled. Accordingly, when the engine decelerates, the fuel supply is cut off. Immediately after the fuel supply resumes, the above-described enriching control is executed. In this case, in step 104, the condition for calculating the value of deviation “d” is not satisfied when the fuel supply is cut off during the enriching control, or immediately after the completion of the enriching control. That is, the condition is not satisfied because the air-fuel ratio of exhaust gas flowing out of the three-way catalyst device 1 is not close to the stoichiometric air-fuel ratio.

If an affirmative determination is made based on the newly calculated integral term I in step 106, it is determined that the value of the flag F is 1 in step 107, because an affirmative determination is made in step 101. Therefore, in step 111, it is determined whether the absolute value of the difference between the newly calculated integral term Iᵢ and the current integral term Iᵢ₋₁ exceeds a predetermined value “c”. When an affirmative determination is made in step 111, the current integral term Iᵢ₋₁ is updated to the newly calculated integral term Iᵢ in step 112.

In step 109, it is determined that the current integral term Iᵢ₋₁ has sufficiently converged to the value appropriate for correcting the deviation of the output from the air-fuel ratio sensor 2. Therefore, if the absolute value of the difference between the newly calculated integral term Iᵢ and the current integral term Iᵢ₋₁ is large, it is determined that the condition of the air-fuel ratio sensor 2 has changed, and the current integral term Iᵢ₋₁ is updated to the newly calculated integral term Iᵢ. However, if the absolute value of the difference is small, it is determined that the condition of the air-fuel ratio sensor 2 has not changed, and the current integral term Iᵢ₋₁ is not updated to the newly calculated integral term Iᵢ. Thus, the air-fuel ratio control is stably executed.

As described above, the fuel-cutoff prohibition period in which the fuel supply cutoff is prohibited is set. That is, the fuel supply cutoff is prohibited until the integral term I converges to the value appropriate for correcting the deviation of the output from the air-fuel ratio sensor 2, as a result of updating the integral term I a plurality of times. Thus, the integral term I is reliably updated to the value appropriate for correcting the deviation of the output from the air-fuel ratio sensor 2. As a result, the output from the air-fuel ratio sensor 2 is appropriately corrected during the enriching control executed immediately after fuel supply resumes, and during the stoichiometric control.

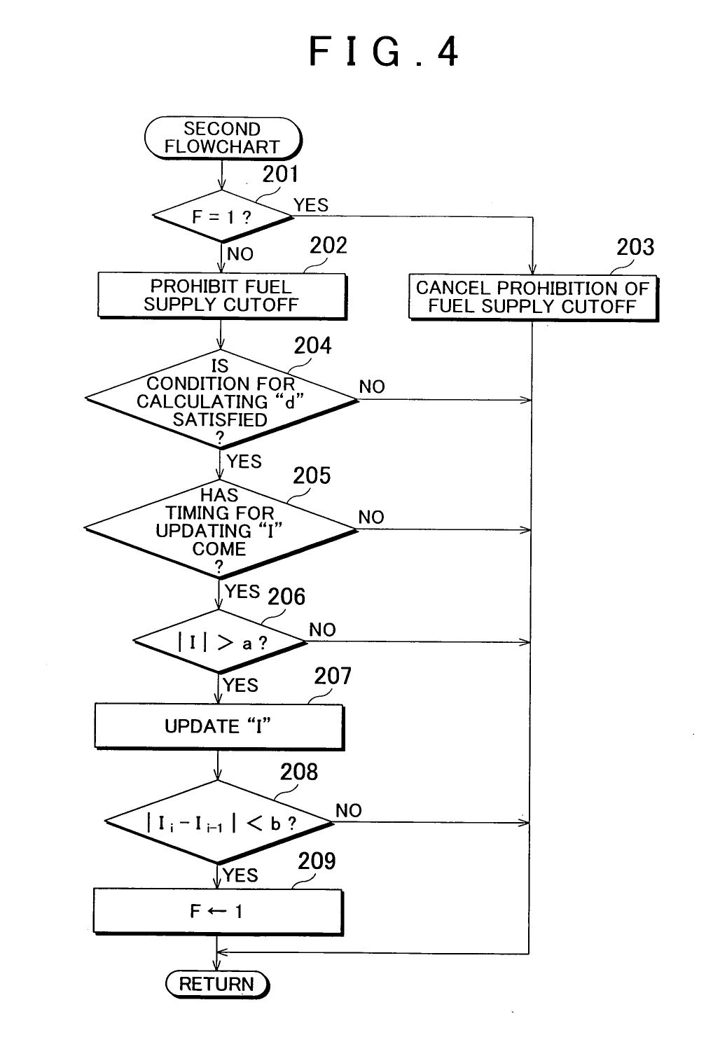

FIG. 4 shows a second flowchart used instead of the first flowchart in FIG. 3.

The routine shown by the second flowchart differs from the routine shown by the first flow chart in that after the value of the flag F is set to 1, the prohibition of the fuel supply cutoff is cancelled, and the routine is terminated. That is, after the prohibition of the fuel supply cutoff is cancelled in step 203, the routine is terminated. Therefore, in the routine shown by the second flowchart, steps 104 to 112 in the first flowchart are not executed after the prohibition of the fuel supply cutoff is cancelled. Steps 201 and 202, and steps 204 to 209 are the same as steps 101 and 102, and steps 104 to 106, and steps 108 to 110 in the first flowchart, respectively.

In the second flowchart, when the integral term I has converged to the value appropriate for correcting the deviation of the output from the air-fuel ratio sensor 2 (step 208), the value of the flag F is set to 1 (step 209), and the prohibition of the fuel supply cutoff is cancelled (step 203), as in the first flowchart. In this case, the updating of the integral term I is prohibited to stably execute the air-fuel ratio control.

In the above-described first and second flowcharts, the fuel-cutoff prohibition period starts when the engine starts. However, the invention is not limited to this configuration. The fuel-cutoff prohibition period for updating the integral term I may start at any time when the engine is operating. In the above-described first and second flowcharts, the fuel supply cutoff is prohibited until the integral term I converges to the value appropriate for correcting the deviation of the output from the air-fuel ratio sensor, as a result of updating the integral term I a plurality of times. However, the invention is not limited to this configuration. If the integral term I is updated at least once, the integral term I may be regarded as having converged to the value appropriate for correcting the deviation of the output from the air-fuel ratio sensor 2. In this case, after the integral term I is updated at least once, the updated integral term I can be used during the stoichiometric control and the enriching control. Therefore, the prohibition of the fuel supply cutoff may be cancelled when the integral term I is updated.

What is claimed is:

1. An air-fuel ratio control apparatus for an internal combustion engine, which includes an air-fuel ratio sensor that is disposed upstream of a three-way catalyst device provided in an engine exhaust system, and an output from which changes according to an air-fuel ratio of exhaust gas; and an oxygen sensor that is disposed downstream of the three-way catalyst device, and an output from which sharply changes when the air-fuel ratio of the exhaust gas approaches a stoichiometric air-fuel ratio, wherein the air-fuel ratio control apparatus controls a combustion air-fuel ratio to a desired air-fuel ratio, based on the output from the air-fuel ratio sensor, wherein:
the output from the air-fuel ratio sensor is corrected using an integral term, which is calculated by integrating values of deviation of the output from the oxygen sensor with respect to a reference output that would be obtained when the combustion air-fuel ratio is stoichiometric, when the engine operates with a target combustion air-fuel ratio set to the stoichiometric air-fuel ratio;
the integral term is updated when a predetermined updating condition is satisfied; and
a fuel-cutoff prohibition period in which fuel supply cutoff is prohibited is set so that the engine continues to operate with the target combustion air-fuel ratio set to the stoichiometric air-fuel ratio, until the integral term is updated at least once.

2. The air-fuel ratio control apparatus according to claim 1, wherein the fuel-cutoff prohibition period continues until the integral term substantially converges to a value appropriate for correcting the deviation of the output from the air-fuel ratio sensor as a result of updating the integral term a plurality of times.

3. The air-fuel ratio control apparatus according to claim 1, wherein the fuel-cutoff prohibition period continues until an absolute value of a difference between a newly calculated integral term and a current integral term is smaller than a predetermined value.

4. The air-fuel ratio control apparatus according to claim 1, wherein, after the fuel-cutoff prohibition period ends, updating of the integral term is prohibited.

5. The air-fuel ratio control apparatus according to claim 1, wherein, after the fuel-cutoff prohibition period ends, the integral term is updated when an amount by which the integral term has changed exceeds a prescribed value.

6. The air-fuel ratio control apparatus according to claim 1, wherein, after the fuel-cutoff prohibition period ends, a current integral term is updated to a newly calculated integral term only when an absolute value of a difference between the newly calculated integral term and the current integral term exceeds the prescribed value.

7. An air-fuel ratio control method for an internal combustion engine, comprising:
calculating an integral term by integrating values of deviation of an output from an oxygen sensor, disposed downstream of a three-way catalyst device provided in an engine exhaust system, with respect to a reference output that would be obtained when a combustion air-fuel ratio is stoichiometric;
correcting an output from an air-fuel ratio sensor, disposed upstream of the three-way catalyst device, using the integral term when an engine operates with a target combustion air-fuel ratio set to the stoichiometric air-fuel ratio;
controlling the combustion air-fuel ratio to a desired air-fuel ratio based on the corrected output from the air-fuel ratio sensor;
updating the integral term when a predetermined updating condition is satisfied; and
setting a fuel-cutoff prohibition period in which fuel supply cutoff is prohibited so that the engine continues to operate with the target combustion air-fuel ratio set to the stoichiometric air-fuel ratio until the integral term is updated at least once,
wherein, the output from the air-fuel ratio sensor changes according to an air-fuel ratio of exhaust gas, and the output from the oxygen sensor sharply changes when the air-fuel ratio of the exhaust gas approaches a stoichiometric air-fuel ratio.

8. The air-fuel ratio control method according to claim 7, wherein the fuel-cutoff prohibition period continues until the integral term substantially converges to a value appropriate for correcting the deviation of the output from the air-fuel ratio sensor as a result of updating the integral term a plurality of times.

9. The air-fuel ratio control method according to claim 8, wherein the fuel-cutoff prohibition period continues until an absolute value of a difference between a newly calculated integral term and a current integral term is smaller than a predetermined value.

10. The air-fuel ratio control method according to claim 7, wherein, after the fuel-cutoff prohibition period ends, updating of the integral term is prohibited.

11. The air-fuel ratio control method according to claim 7, wherein, after the fuel-cutoff prohibition period ends, the integral term is updated when an amount by which the integral term has changed exceeds a prescribed value.

12. The air-fuel ratio control method according to claim 11, wherein, after the fuel-cutoff prohibition period ends, a current integral term is updated to a newly calculated integral term only when an absolute value of a difference between the newly calculated integral term and the current integral term exceeds the prescribed value.
